(19) United States
(12) Patent Application Publication
(10) Pub. No.: US 2016/0233772 A1
(43) Pub. Date: Aug. 11, 2016

(54) POWER REGULATOR AND SLOPE COMPENSATION

(71) Applicant: Texas Instruments Incorporated, Dallas, TX (US)

(72) Inventors: Joseph G. Renauer, Naperville, IL (US); Joel N. Brassfield, Homer Glen, IL (US)

(21) Appl. No.: 14/986,247

(22) Filed: Dec. 31, 2015

Related U.S. Application Data
(60) Provisional application No. 62/113,204, filed on Feb. 6, 2015.

(51) Int. Cl. H02M 3/158

(52) U.S. Cl. CPC H02M 3/158

(57) ABSTRACT

A power regulator for converting an input voltage to an output voltage includes and inductor, wherein the output voltage of the regulator is in response to charging of the inductor at a clock frequency. An error amplifier has an inverting input coupled to the regulator output, and a non-inverting input coupled to a reference voltage. A slope compensation circuit is for generating a signal for charging the inductor. The compensation circuit includes an output coupled the circuitry for charging the inductor, wherein a signal on the output is generated in response to the input voltage, the output voltage, and the clock frequency.

### CROSS-REFERENCE TO RELATED APPLICATION

This application claims priority to U.S. Provisional Patent Application Ser. No. 62/113,204, filed Feb. 6, 2015, entitled POWER CONVERSION SYSTEM ARCHITECTURE OPTIMIZED FOR POWER MODULES, naming Joseph G. Renauer and Joel N. Brassfield as inventors, which is hereby fully incorporated herein by reference for all purposes.

### BACKGROUND

Modular power regulators convert an input voltage to a regulated output voltage. Many of these power regulators are intended to be general purpose devices that operate over a wide range of input and output voltages. Some power regulators regulate their output voltages by charging and discharging a fixed value inductor that is coupled to the output of the power regulators. The control architecture for these power regulators includes a feedback loop to regulate the output voltage. The feedback loop includes an error amplifier.

Many of the error amplifier topologies exhibit the undesirable characteristic that their system transient responses change dramatically with the output voltage setting. For example, higher output voltage settings may result in higher transient responses. Optimizing the transient responses requires modifying the frequency compensation of the power regulator. For example, each output voltage value has a particular optimum compensation value, which requires components in the power regulator or associated with the power regulator to be changed to match the particular optimum compensation value. Accordingly, when a user changes the output voltage value, the components associated with the frequency compensation have to be changed, which is burdensome on the users.

### SUMMARY

A power regulator for converting an input voltage to an output voltage includes and inductor, wherein the output voltage of the regulator is in response to charging of the inductor at a clock frequency. An error amplifier has an inverting input coupled to the regulator output, and a non-inverting input coupled to a reference voltage. A slope compensation circuit is for generating a signal for charging the inductor. The compensation circuit includes an output coupled the circuitry for charging the inductor, wherein a signal on the output is generated in response to the input voltage, the output voltage, and the clock frequency.

### BRIEF DESCRIPTION OF THE DRAWINGS

FIG. 1 is a block diagram of a conventional modular step-down switching power regulator.

FIG. 2 is a graph of example transient response variations in the output voltage V_{OUT} of the power regulator of FIG. 1 as the load current supplied by V_{OUT} is changed.

FIG. 3 is a graph of example loop gains at different output voltages as a function of frequency for the power regulator of FIG. 1.

FIG. 4 is a block diagram of an example power regulator that overcomes issues related to the power regulator of FIG. 1.

FIG. 5 is a block diagram of an example power stage of the power regulator of FIG. 4.

FIG. 6 is a circuit that generates an adaptive slope compensation signal for a valley current mode power regulator, such as the power regulator of FIG. 4.

FIG. 7 is a block diagram of a power regulator that includes slope compensation and an error amplifier.

### DETAILED DESCRIPTION

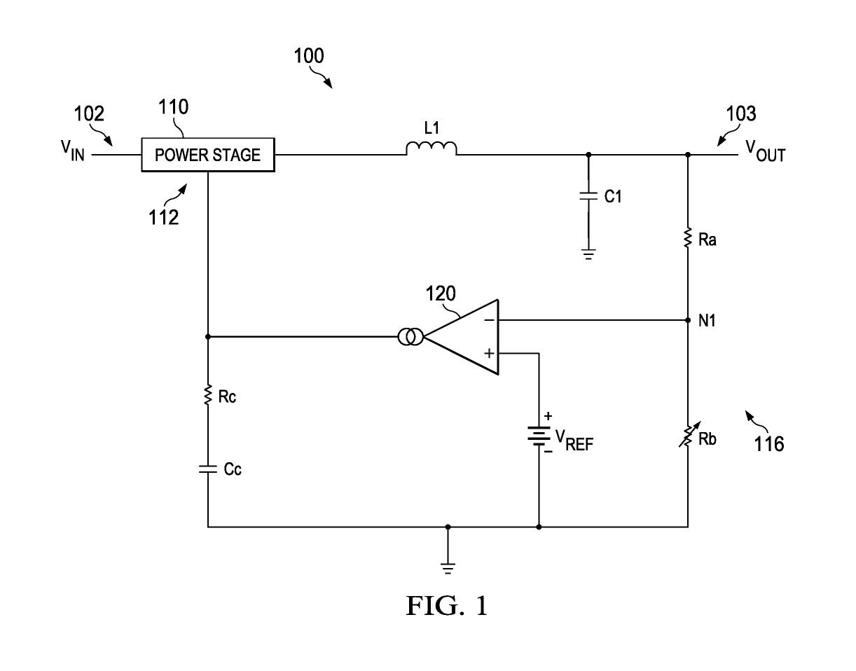

FIG. 1 is a block diagram of a conventional modular step-down switching power regulator 100. Power regulators, such as the power regulator 100 are often implemented as power modules. The power regulator 100 includes an input 102 that receives an input voltage V_{IN} and an output 103 wherein the power regulator generates an output voltage V_{OUT} at the output 103.

The input 102 is coupled to a power stage 110 that generates a drive signal into an inductor L1. In the example of FIG. 1, the drive signal is a pulse width modulated (PMW) signal wherein the widths of the pulses are proportional to a control signal received at an input 112 of the power stage 110. In the example of FIG. 1, the control signal is a voltage that is proportional to the difference between the output voltage V_{OUT} and a target output voltage. The inductor L1 is fed with a signal, such as PWM pulses of the input voltage V_{IN}. These PWM pulses are rectangular pulses of voltage and are integrated by the inductor L1 into triangular current pulses that charge a capacitor C1. The charging current into the capacitor C1 determines the output voltage V_{OUT}.

The output 103 is coupled to a voltage divider 116 that consists of two resistors Ra and Rb, wherein the resistor Rb is variable. As described in greater detail below, the value of the resistor Rb sets the value of the output voltage V_{OUT}. The output of the voltage divider 116 is a node N1 that is coupled to the inverting input of an error amplifier 120. The non-inverting input of the error amplifier 120 is coupled to a reference voltage V_{REF}, which in some examples is a very stable and precise reference voltage. The output voltage V_{OUT} is set by the voltage divider 116. More specifically, the output voltage V_{OUT} is divided down so that the voltage at the inverting input of the error amplifier 120 is equal to the value of the reference voltage V_{REF}.

In the example of FIG. 1, the error amplifier 120 is a transconductance amplifier, which means it generates an output current that is proportional to the difference in the voltages present at the inverting and non-inverting inputs. The output of the error amplifier 120 drives frequency compensation components consisting of a resistor Rc and a capacitor Cc. The output of the error amplifier 120 also drives the control input 112 of the power stage 110. As described above, the control input is used to generate the drive signal generated by the power stage 110. The example of the drive signal in the power regulator 100 is a PWM signal wherein the control signal determines the widths of the PWM signal to maintain the output voltage V_{OUT} at its target value.

Power regulators such as the power regulator 100 have the undesirable characteristic that the system loop bandwidth varies directly with the amount of attenuation produced by the voltage divider 116. The greater the target output voltage, the greater the attenuation required by the voltage divider 116.

In a conventional power regulator, such as the power regulator 100, a fixed reference voltage V_{REF} is applied to the non-inverting input of the error amplifier 120. The output voltage V_{OUT} is set by the resistive voltage divider 116. The greater the target output voltage V_{OUT}, the greater the required attenuation by the voltage divider 116. The principal disadvantage of this configuration is that the loop gain of the power regulator 100 is attenuated by the same amount as the voltage applied to the inverting input to the error amplifier 120. The voltage change at the input to the error amplifier 120 causes the loop gain of the power regulator 100 to change with the output voltage V_{OUT}. The change in loop gain degrades the transient response of the power regulator 100 as described below. Another disadvantage of the power regulator 100 is that when it is implemented in an integrated circuit package, an additional node is required to monitor the output voltage V_{OUT} of the power regulator 100. More specifically, the power regulator 100 does not monitor the actual value of the output voltage V_{OUT}/rather; the output voltage V_{OUT} is always attenuated to the same value as the reference voltage V_{REF}.

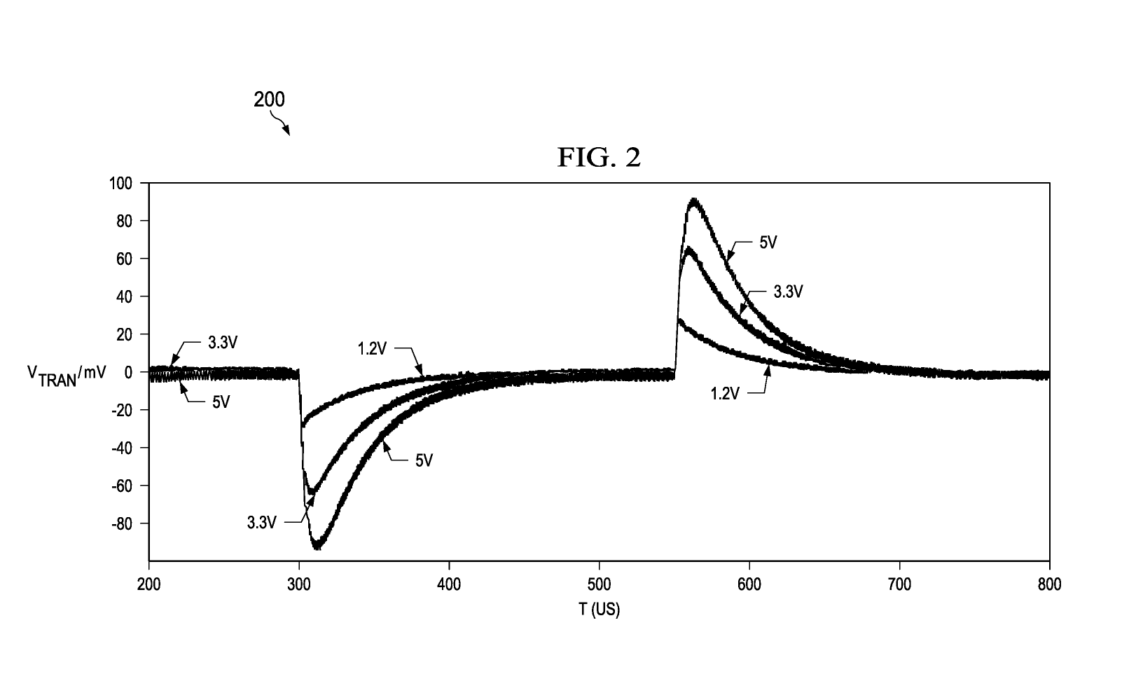

FIG. 2 is a graph 200 of example transient response variations in the output voltage V_{OUT} of the power regulator 100 as the load current supplied at the output 103 is changed or due to changes in the load current. As described above, the output voltage V_{OUT} is set by changing the value of the resistor Rb. The graph 200 shows the normalized voltage deviation in the output voltage V_{OUT} in response to a 10A load transient with an input voltage of 12V and output voltages of 5V, 3.3V, and 1.2V. In the graph of FIG. 2, only the output voltage V_{OUT} was changed by varying the resistance of the resistor Rb. The frequency compensation components and output capacitance values are the same in all cases. As shown by the graph 200, the voltage deviation for the 5V output is almost three times the voltage deviation for the 1.2V output. If this variation is not acceptable to a user, then the frequency compensation of the power regulator 100 has to be modified to reduce the amplitude of the transient swing. Each output voltage value will have its own optimum compensation value. This configuration is difficult to implement, especially in circuit packages where users do not have access to the compensation components.

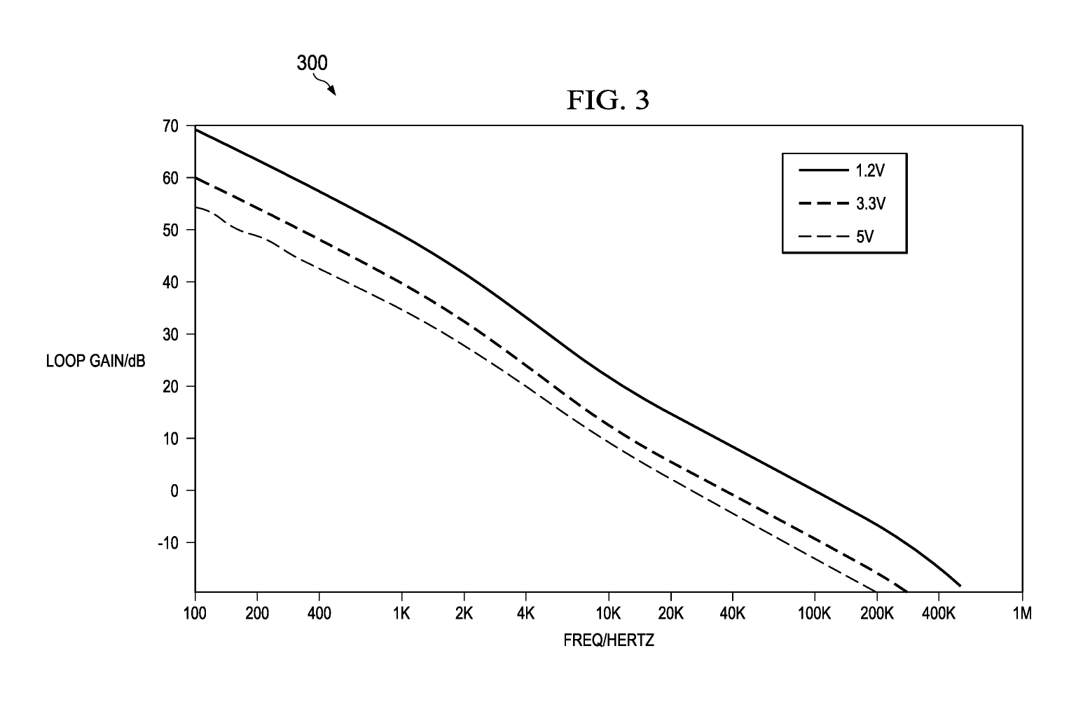

FIG. 3 is a graph 300 of example loop gains at different output voltages as a function of frequency for the power regulator 100 of FIG. 1. The graph 300 shows the loop bandwidth of the power regulator 100 at the three different output voltages shown in the graph 200 of FIG. 2. The crossover frequency, where the gain is zero, varies from 100 kHz down to approximately 25 kHz. As shown by the graph 300, the crossover frequency is 100 kHz when the output voltage V_{OUT} is set to 1.2V, but it decreases to about 25 kHz when the output voltage V_{OUT} is 5V.

Transient response behavior is a direct function of loop bandwidth. The higher the loop bandwidth, the faster the power regulator 100 will respond to load changes and output voltage deviation is reduced. Lower loop bandwidth degrades transient response as shown by the graphs 200 and 300. The low loop bandwidth may require a user of the power regulator 100 to add more output capacitance to reduce the swing of the output voltage V_{OUT}. In other situations, the low loop bandwidth may require changing the value of the compensation components to restore the loop bandwidth to its optimum value. In many power regulators, the compensation components are internal and fixed, so the user has no access to them.

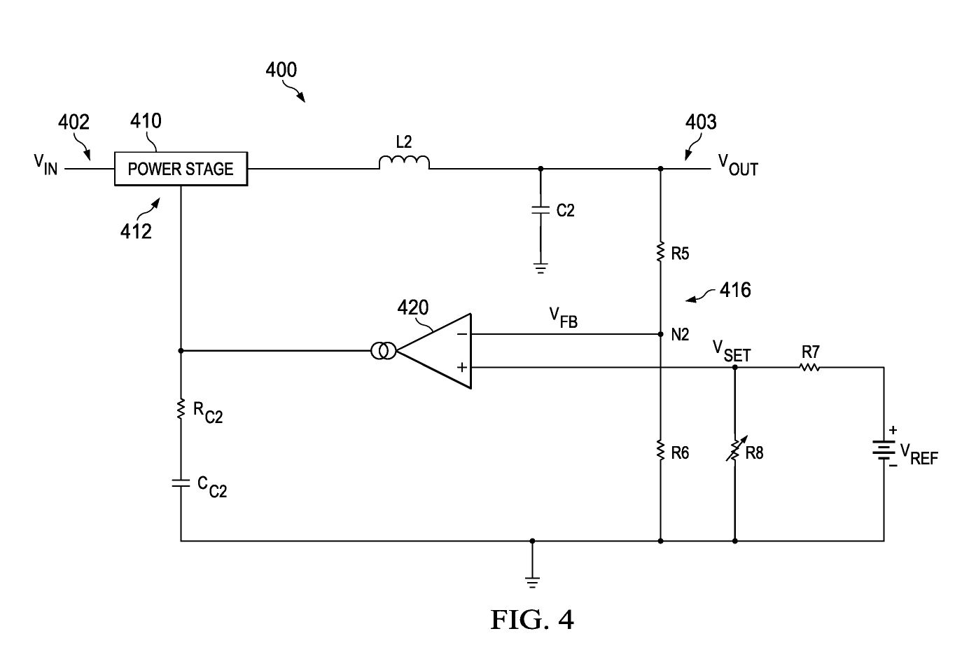

FIG. 4 is a block diagram of an example power regulator 400 that overcomes issues related to the power regulator 100 of FIG. 1. The power regulator 400 greatly reduces the variation in loop gain over a wide range of input and output voltages. The loop gain is maintained so that a user does not have to recalculate the value of any compensation components when selecting a different output voltage. The power regulator 400 includes a voltage input 402 and a voltage output 403. The power regulator 400 receives an input voltage V_{IN} at the input 402 and generates an output voltage V_{OUT} at the output 403.

The voltage input 402 is coupled to a power stage 410. The power stage 410 generates a drive signal into an inductor L2. In the example of FIG. 4, the drive signal is a pulse width modulated signal wherein the widths of the pulses are proportional to a control signal received at an input 412 of the power stage 410. In the example of FIG. 4, the control signal is a voltage that is proportional to the difference between the output voltage V_{OUT} and a target output voltage. The inductor L2 is fed with pulse width modulated pulses of the input voltage. These rectangular pulses of voltage are integrated by the inductor L2 into triangular current pulses that charge a capacitor C2. The charging current into the capacitor C2 determines the output voltage V_{OUT}.

The voltage output 403 is coupled to a voltage divider 416 consisting of two resistors R5 and R6. The voltage divider 416 in the example power regulator 400 is set to a fixed value. More specifically, neither the resistor R5 nor the resistor R6 are variable resistors. The output of the voltage divider 416 is a node N2, which is coupled to the inverting input of an error amplifier 420. In the example of FIG. 4, the output voltage V_{OUT} is divided by two by the voltage divider 416, so the voltage at the node N2 is half the output voltage V_{OUT}.

In the example power regulator 400, the error amplifier 420 is substantially similar or identical to the error amplifier 120 of FIG. 1. The example error amplifier 420 is a transconductance amplifier, which means it generates an output current that is proportional to the difference in the voltages present at the inverting and non-inverting inputs. The output of the error amplifier 420 drives frequency compensation components consisting of a resistor R_{C2} and a capacitor C_{C2}. The output of the error amplifier 420 also drives the control input 412 of the power stage 410. As described above, the control input 412 receives a control signal generated by the error amplifier 420. The example of the drive signal generated by the power stage 410 is a PWM signal wherein the control signal determines the widths of the pulses of the PWM signal to maintain the output voltage V_{OUT} at its target value.

The non-inverting input of the error amplifier 420 is coupled to a resistor R7 and a resistor R8 wherein the resistor R8 is a variable resistor. The resistor R8 is coupled to ground and the resistor R7 is coupled to a reference voltage V_{REF}. Unlike the conventional error amplifiers, the voltage V_{SET} presented to the non-inverting input of the error amplifier 420 is not fixed. The voltage V_{SET} is set by the user to set the output voltage V_{OUT}. In the example power regulator 400, the voltage V_{SET} is derived from a voltage divider that includes the reference voltage V_{REF}. In the embodiment of FIG. 4, the voltage reference V_{REF} is a precision fixed reference voltage of 3.00V. The example power regulator 400 has the voltage divider from V_{OUT} to the inverting input of the error amplifier 420 set to a fixed value of one half. Accordingly, the required value for V_{SET} is V_{OUT}/2. In one example wherein the power regulator 400 has a target output voltage V_{OUT} of 1.20V, the voltage V_{SET} must be set to 0.60V. The power regulator 400 enables the output voltage V_{OUT} of the voltage regulator 400 to be very low. For example, output voltages less than 0.6 volts can be achieved because the set voltage V_{SET} is not constrained to a fixed lower limit. Accordingly, the output voltage can be taken as low as needed to achieve the target output voltage V_{OUT} because the set voltage V_{SET} is less than the reference voltage V_{REF}. The use of the resistors R7 and R8 is an example of the generation of the set voltage V_{SET}. Other circuitry may be implemented to generate the set voltage V_{SET}.

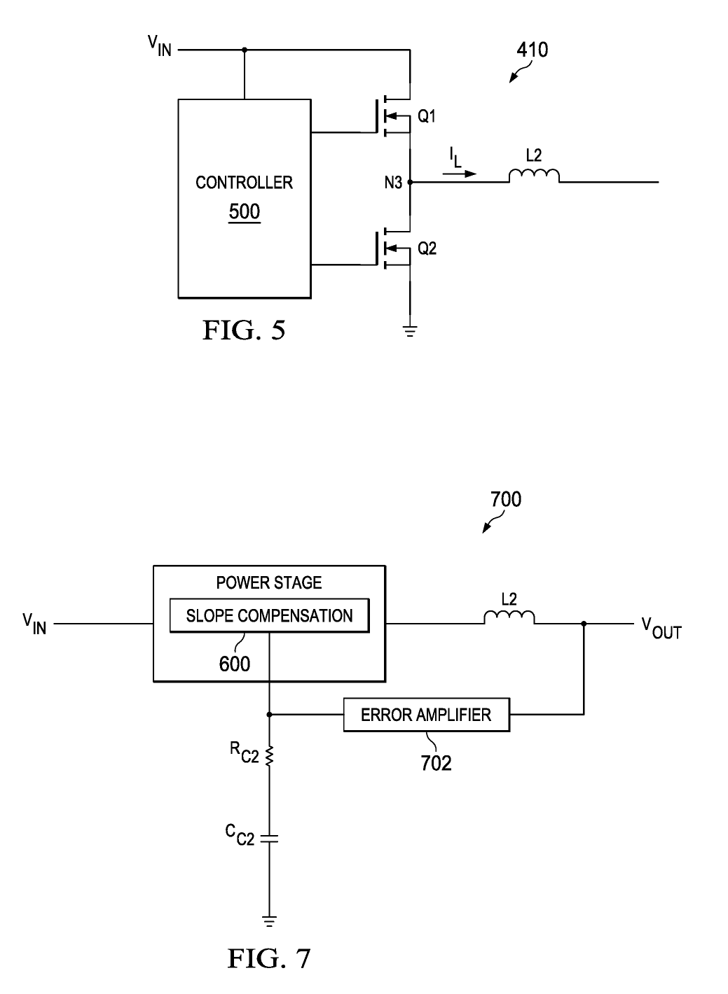

FIG. 5 is a block diagram of an example power stage 410 from the power regulator 400 of FIG. 4. The power stage 410 includes two switches, which in the embodiment of FIG. 4 are field-effect transistors (FETs) Q1 and Q2. Transistor Q1 is referred to as the high side FET and Q2 is referred to as the low side FET. A node N3 is located between the two FETs Q1 and Q2 and couples to the inductor L2. The FETs Q1 and Q2 are turned on and off for different periods, which charge and discharge the inductor L2. The charge and discharge time of the inductor L2 sets the output voltage V_{OUT}. Some power stages or power supplies have components that measure the current I_{L} flowing through the inductor L2. Some power stages deduce the current flowing in the inductor L2 by measuring the current flowing through transistor Q1 during the on-time of the PWM pulse, or measuring the current flowing through transistor Q2 during the off-time of the PWM pulse.

When using peak-current mode control, the minimum PWM pulse width that can be generated by the power stage 410 is determined by how fast a valid sample of the current through the inductor L2 can be obtained during the time that the high side FET Q1 is on. When the high side FET Q1 turns on, it creates a large amount of noise in the power stage 410 and the power regulator 400, FIG. 4. During the turn on, the voltage at the node N3 slews from a ground potential (or other predetermined potential) to the value of the input voltage V_{IN} in a few nanoseconds. In many instances, the fast slew produces ringing at the node N3, which interferes with the accurate measurement of the current through the inductor L2. In some examples, a blanking interval is required that allows the ringing to decay before the current through the inductor L2 can be measured. The blanking interval is typically approximately 100 ns, which dictates the minimum pulse width that can be generated by the power stage 410.

The minimum pulse width sets the maximum V_{IN} to V_{OUT} step-down ratio that can be achieved at a given switching frequency. This yields the minimum output voltage V_{OUT} (min) as a function of the minimum pulse width PW(min) and switching frequency Fsw given by equation (1) as follows:

V_{OUT}(min)=V_{IN}*PW(min)*Fsw Equation (1)

In one example, the minimum pulse width is 100 ns, the input voltage V_{IN} is 12V and the switching frequency Fsw is 1 MHz. In this example, the minimum output voltage is 1.2V. In order to provide a higher input voltage V_{IN} or a lower output voltage V_{OUT}, the switching frequency Fsw must be lowered. If the power regulator 400 is operated beyond the minimum pulse width, pulses will typically be skipped, which lowers the switching frequency, which increases ripple and causes other anomalies.

In some examples of the power regulator 400, when current mode control is used as part of the regulation method, slope compensation is provided to prevent sub-harmonic oscillations of the output voltage under certain V_{IN} and V_{OUT} conditions. A slope compensation ramp voltage V_{RAMP} (described below) is summed with the inductor current sense signal and is applied to one input of a comparator, the other input to the comparator is the output of the error amplifier 420. If valley-current mode is implemented as part of the regulation method, when the falling summed V_{RAMP} and the current sense signal crosses the signal output by the error amplifier 420 signal, the comparator fires and sets a latch. The firing of the latch starts the PWM pulse. The latch is reset on the next system clock, such as the rising edge of a clock, providing the switching frequency Fsw. The clock signal terminates the PWM pulse. This produces leading-edge modulation. The PWM pulse may be generated in the controller 500 and drives the gate of the high side FET Q1 and an inverted PWM pulse drives the gate of the low side FET Q2.

If peak-current mode is implemented as part of the regulation method, the PWM signal begins when the system clock sets a PWM latch. When the rising edge of the summed voltage V_{RAMP} and the current sense signal crosses the signal output of the error amplifier, the comparator fires and resets the latch, terminating the PWM pulse. This produces trailing-edge modulation.

Many slope compensation ramp functions are static and cannot accommodate for changes in the power regulator operating conditions. These ramp functions do not provide the optimum slope compensation waveforms. The circuits and methods described herein overcome the above-described problems by generating an adaptive slope compensation ramp that has an amplitude that varies as the input voltage V_{IN}, the output voltage V_{OUT}, or the switching frequency Fsw varies. For peak current mode systems, the ideal slope compensation ramp obeys equation 2 as follows:

Se=V_{OUT}*Ri/L Equation (2)

where Ri is the current sense gain in volts/amp, and L is the inductance value of the inductor L2. For valley current mode the ideal slope follows equation 3 as follows:

Se=(V_{IN}−V_{OUT})*Ri/L Equation (3)

In both cases, the value of the output voltage V_{OUT} is required in order to generate the optimum compensation ramp slope. The power regulator 400 provides the output voltage V_{OUT} with the feedback signal V_{FB} at the node N2.

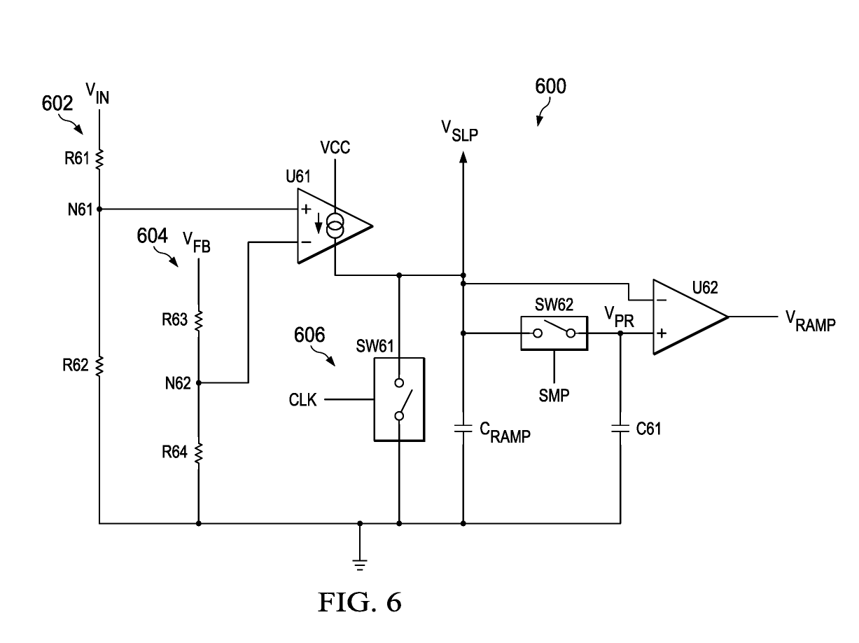

FIG. 6 is a circuit 600 that generates an adaptive slope compensation signal V_{RAMP} for a valley current mode power regulator, such as the power regulator 400. The signal V_{RAMP} produced by the circuit 600 automatically adjusts for variation in the input voltage V_{IN}, the output voltage V_{OUT}, and the switching frequency Fsw. In generating the signal V_{RAMP}, the circuit 600 implements equation 3. The circuit 600 includes a first input 602 that is coupled to the input voltage V_{IN}. A second input 604 is coupled to the node N2 of the power regulator 400. The voltage at the node N2 is referred to as the feedback voltage V_{FB} and is proportional to the output voltage V_{OUT}. A third input 606 is coupled to the system clock CLK and operates a switch SW61 at the switching frequency Fsw.

The first input 602 is coupled to a resistor R61 that is coupled to a resistor R62 at a node N61. The resistors R61 and R62 may divide the input voltage V_{IN} down so that the voltage at the node N61 is one fifth the input voltage V_{IN}. The second input 604 is coupled to a resistor R63 that is coupled to a resistor R64 at a node N62. The feedback voltage V_{FB} in the examples described herein is half the output voltage V_{OUT}. The resistors R63 and R62 divide the feedback voltage down to where the voltage at the node N62 is one fifth the output voltage V_{OUT}. Accordingly, the voltage at the node N61 is the same proportion of the input voltage V_{IN} as the voltage at the node N62 is to the output voltage V_{OUT}.

The circuit 600 includes a voltage controlled current source U61 that has a non-inverting input and an inverting input. The non-inverting input is coupled to the node N61 and the inverting input is coupled to the node N62. The net effect of these connections is to produce a signal that is proportional to (V_{IN}−V_{OUT}). The current source U61 provides current to charge a ramp capacitor C_{RAMP}. The gain of the current source U61 may be adjusted to account for the values of Ri and L. The ideal gain of the current source U61 is (5*C_{RAMP}*Ri)/L based on the inputs to the power stage being one fifth of the input voltage V_{IN} and the output voltage V_{OUT}. In one example, C_{RAMP} is 10 pF, Ri is 40 mV/A and L is 0.4 uH, then the gain of the current source U1 is set to 5 uS. The switch SW61 discharges the capacitor C_{RAMP} at the beginning of each switching period with a narrow pulse by way of the coupling of the switch SW61 to the clock CLK operating at the switching frequency Fsw.

The voltage across the ramp capacitor C_{RAMP} is referred to as the slope compensation ramp voltage V_{SLP}. The peak value of the slope compensation ramp voltage V_{PR} is captured and held by means of a switch SW62 and a capacitor C61. The switch SW62 is controlled by a pulse SMP that is generated just before the clock pulse CLK discharges the ramp capacitor C_{RAMP}. A differential buffer U62 subtracts the slope compensation ramp voltage V_{SLP} from the peak value of the slope compensation ramp voltage V_{PR} and outputs the above-described ramp voltage V_{RAMP}. The ramp voltage V_{RAMP} is the downward sloping compensation ramp that valley mode control uses to switch the FETs Q1 and Q2 of FIG. 5. For a peak current mode control system, a similar circuit that implements equation 2 is used.

When the adaptive slope compensation of the circuit 600 is implemented the transient response is uniform as the input voltage V_{IN} is changed over a wide range, such as a 3:1 range. The gain and phase of the power regulator 400 do not vary with changes in the input voltage V_{IN}. When the benefits of this adaptive slope compensation circuit are combined with the benefits of the revised error amplifier topology described above, the loop bandwidth of the power regulator 400 does not change with variations in input voltage VIN or output voltage V_{OUT}. This stabilization of the loop bandwidth eliminates the need for custom compensation for each different output voltage V_{OUT}. With this solution, one value of inductor Li can be used over a wide input voltage V_{TN} and output voltage V_{OUT} range. Another advantage of transient response of the circuit 400 is a reduction in the amount of output capacitance required to meet a particular transient requirements, which reduces overall size and cost of the power regulator 400, especially when it is fabricated as a power module. Furthermore, the circuit 600 enables very narrow PWM pulse widths, such as down to approximately 20 ns. This capability can be used to create high V_{TN}/V_{OUT} step-down ratios, and/or operation at higher switching frequencies Fsw. Higher frequency operation enables higher loop bandwidth, which improves transient performance, and reduces the size of the power regulator 400.

FIG. 7 is a block diagram of a power regulator 700 that includes slope compensation 600 and an error amplifier 702. The error amplifier 702 may include the error amplifier 420 of FIG. 4 and the associated components. As shown in FIG. 7, the slope compensation 600 works with the power stage to generate the PWM pulses that drive the current through the inductor L2. The combination of the slope compensation as described with reference to FIG. 6 and the error amplifier 702 yields the improved frequency bandwidth and other improvements over conventional power regulators.

While some examples of power regulators have been described in detail herein, it is to be understood that the inventive concepts may be otherwise variously embodied and employed and that the appended claims are intended to be construed to include such variations except insofar as limited by the prior art.

What is claimed is:

1. A power regulator for converting an input voltage to an output voltage, the power regulator comprising:
a regulator input for coupling the power regulator to the input voltage;
a regulator output for outputting the output voltage;
a power stage having a power stage input coupled to the regulator input, a control input, and a power stage output;
an inductor coupled between the power stage output and the regulator output, the power stage for charging the inductor in response to a clock signal;
an error amplifier having an output coupled to the control input, an inverting input coupled to the regulator output, and a non-inverting input coupled to a reference voltage; and
a slope compensation circuit for generating a signal for charging the inductor by the power stage, the compensation circuit comprising an output coupled the power stage, wherein a signal on the output is generated in response to the input voltage, the output voltage, and the frequency of the clock signal.

2. The power regulator of claim 1, wherein the error amplifier comprises a transconductance amplifier.

3. The power regulator of claim 1, comprising a voltage divider coupled between the regulator output and a ground, the voltage divider having an output coupled to the inverting input of the error amplifier.

4. The power regulator of claim 1, further comprising a voltage divider for reducing the output voltage presented to the inverting input of the error amplifier.

5. The power regulator of claim 1, further comprising a voltage divider for presenting one half the output voltage to the inverting input of the error amplifier.

6. The power regulator of claim 1, wherein the voltage at the non-inverting input of the error amplifier is variable.

7. The power regulator of claim 1, further comprising:
a first resistor coupled between the non-inverting input of the error amplifier and the reference voltage; and
a second resistor coupled between the non-inverting input of the error amplifier and a ground, wherein the second resistor is variable.

8. The power regulator of claim 1, wherein the slope compensation circuit comprises:
a first input coupled to the regulator input;
a second input coupled to the regulator output;
a third input coupled to the clock for generating pulses to charge the inductor.

9. The power regulator of claim 1, wherein the slope compensation circuit comprises:
a voltage controlled current source having a first input coupled to the first input of the slope compensation circuit, a second input coupled to the second input of the slope compensation input, and an output;
a first switch coupled between the output of the voltage controlled current source and a ground, the first switch having a control coupled to the third input; and
a first capacitor coupled in parallel with first switch, wherein the first switch is for discharging the first capacitor.

10. The power regulator of claim 9, wherein the slope compensation circuit further comprises:
a differential buffer having a buffer first input, a buffer second input, and a buffer output, wherein the buffer output is coupled to the output of the compensation circuit, and wherein the buffer first input is coupled to the output of the voltage controlled current source;
a second switch coupled between the output of the voltage controlled current source and the buffer second input, the second switch for opening during peak voltages across the first capacitor; and
a second capacitor coupled between the buffer second input and ground, the second capacitor for storing the peak voltages.

11. The power regulator of claim 1, wherein the power stage includes:
a high side field-effect transistor (FET) coupled between the power stage input and the power stage output;
a low side FET coupled between the power stage output and ground;
a controller coupled to the gate of the high side FET and the gate of the low side FET, the controller for turning the high side FET and the low side FET on and off in response to the signal output by the slope compensation.

12. A power regulator comprising:
a regulator for receiving an input voltage and generating an output voltage by driving current into an inductor, the regulator comprising a clock operating at a clock frequency for setting time that the current is driven into the inductor;
a slope compensation circuit for generating a signal for driving current into the inductor, the slope compensation circuit comprising:
a first input coupled to the input voltage;
a second input coupled to the output voltage output;
a third input coupled to the clock; and
a slope compensation output coupled the regulator, wherein a signal on the slope compensation output is generated in response to the input voltage, the output voltage, and the frequency of the clock.

13. The power regulator of claim 12, wherein the slope compensation circuit further comprising:
a voltage controlled current source having a first input coupled to the first input of the compensation circuit, a second input coupled to the second input of the compensation input, and a current output;
a first switch coupled between the current output and a ground, the first switch having a control coupled to the third input; and
a first capacitor coupled in parallel with the first switch, wherein the first switch is for discharging the first capacitor in response to the frequency of the clock.

14. The slope compensation circuit of claim 13, further comprising:
a differential buffer having a buffer first input, a buffer second input, and a buffer output, wherein the buffer output is the coupled to the output of the compensation circuit, and wherein the buffer first input is coupled to the current output;
a second switch coupled between the current output and the buffer second input, the second switch for opening during peak voltage levels across the first capacitor; and
a second capacitor coupled between the buffer second input and ground, the second capacitor for storing the peak voltages.

15. The power regulator of claim 12, wherein the regulator comprises:
a regulator input for coupling to an input voltage;
a regulator output for outputting an output voltage;
a power stage having a power stage input coupled to the regulator input, a control input, and a power stage output, the power stage for driving current into the inductor;
an error amplifier having an output coupled to the control input, an inverting input coupled to the regulator output, and a non-inverting input coupled to a reference voltage, the error amplifier for generating signals to control signals from driving current into the inductor.

16. The power regulator of claim 15, comprising a voltage divider coupled between the regulator output and a ground, the voltage divider having an output coupled to the inverting input of the error amplifier.

17. The power regulator of claim 15, further comprising a voltage divider for reducing the output voltage presented to the inverting input of the error amplifier.

18. The power regulator of claim 15, further comprising a voltage divider for presenting one half the output voltage to the inverting input of the error amplifier.

19. The power regulator of claim 15, wherein the voltage at the non-inverting input of the error amplifier is variable.

20. A power regulator for converting an input voltage to an output voltage, the power regulator comprising:
a regulator input for coupling the power regulator to the input voltage;
a regulator output for outputting the output voltage;
a power stage having a power stage input coupled to the regulator input, a control input, and a power stage output;
an inductor coupled between the power stage output and the regulator output, the power stage for charging the inductor in response to a clock signal;
an error amplifier having an output coupled to the control input, an inverting input coupled to the regulator output, and a non-inverting input coupled to a reference voltage; and
a slope compensation circuit for generating a signal for charging the current, the slope compensation circuit comprising:
a first input coupled to the input voltage;
a second input coupled to the output voltage output;
a third input coupled to the clock signal; and
a slope compensation output coupled the regulator, wherein a signal on the slope compensation output is generated in response to the input voltage, the output voltage, and the frequency of the clock.
